(19) United States
(12) Patent Application Publication
(10) Pub. No.: US 2018/0130298 A1
(43) Pub. Date: May 10, 2018

(54) GAMING DEVICES WITH PATTERN-BASED AWARD EVALUATIONS

(71) Applicant: KING SHOW GAMES, INC., Minnetonka, MN (US)

(72) Inventor: Adam KOSHOREK, Minneapolis, MN (US)

(21) Appl. No.: 15/806,779

(22) Filed: Nov. 8, 2017

Related U.S. Application Data
(60) Provisional application No. 62/419,430, filed on Nov. 8, 2016.

(51) Int. Cl. G07F 17/32; G07F 17/34

(52) U.S. Cl. CPC G07F 17/3244; G07F 17/34; G07F 17/3213

(57) ABSTRACT

Embodiments of the present invention set forth systems, apparatuses and methods for implementing pattern-based award evaluations in gaming devices. Accordingly, a gaming device including a display having a game grid of symbols positions can be configured to store a plurality of different pay patterns associated with the symbol positions of the game grid. Each of the pay patterns may be associated with an award value, and each of the symbol types may be associated with a multiplier value, although this relationship may be reversed. Hence, during evaluation, if a particular symbol fills a section of the game grid matching one of the stored pay patterns, an award may be presented based on the award value of the pay pattern times the multiplier value associated with the symbol.

### RELATED APPLICATIONS

This application claims the benefit of Provisional Patent Application No. 62/419,430, filed on Nov. 8, 2016, to which priority is claimed pursuant to 35 U.S.C. § 119(e) and which is incorporated herein by reference in its entirety.

### FIELD OF THE INVENTION

This disclosure relates generally to games, and more particularly to systems, apparatuses and methods for providing pattern-based award evaluations in gaming devices.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes methods, systems, and apparatus that provide for new and interesting gaming experiences, and that provide other advantages over the prior art.

### SUMMARY

To overcome limitations in the prior art described above, and to overcome other limitations that will become apparent upon reading and understanding the present specification, embodiments of the present invention are directed to an apparatus, system, computer readable storage media, and/or method that involve or otherwise facilitate pattern-based award evaluations in gaming devices. According to some embodiments, a gaming device includes a display having a game grid of symbols positions, a memory configured to store a plurality of different pay patterns associated with the symbol positions of the game grid, and a processor. The processor may be operable to initiate a gaming event where a plurality of game reels each having a plurality of game symbols spin in the game grid as the result of receiving a wager on the gaming event. The processor may further be operable to determine a game outcome and display the game outcome on the game grid by stopping the multiple reels to display a symbol (or blank) in each of the symbol positions of the game grid. The processor may then evaluate the game grid by comparing the game grid to each of the stored patterns to determine whether any pattern includes matching game symbols. Here, each of the pay patterns may be associated with an award value, and each of the symbol types may be associated with a multiplier value, although this relationship may be reversed. Hence, during evaluation, if a particular symbol fills a section of the game grid matching one of the stored pay patterns, an award may be presented based on the award value of the pay pattern times the multiplier value associated with the symbol.

In other embodiments, the player may hold one or more of the symbols received on the game grid and re-spin the game reels to fill the remaining, non-held symbol positions with new symbols in an attempt to achieve a different, better, or higher paying pattern. This may require a side wager, which may be required prior to the first gaming event, or may be paid upon seeing the result of the first gaming event.

### BRIEF DESCRIPTION OF THE DRAWINGS

FIG. 1 is a diagram of a gaming machine according to embodiments of the invention.

FIG. 2 is a block diagram illustrating a computing arrangement according to embodiments of the invention.

FIGS. 3A-3T are block diagrams of game grids showing example evaluation patterns according to embodiments of the invention.

FIGS. 4A-4D are detail diagrams of a gaming display showing a game progression according to embodiments of the invention.

FIGS. 5A-5J are detail diagrams of a gaming display showing another game progression according to embodiments of the invention.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatus.

In various embodiments of the invention, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for providing pattern-based award evaluations in gaming activities. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. slot game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that utilizes operations of providing pattern-based award evaluations in gaming devices. In one embodiment, a method of operating a gaming device includes evaluating symbol patterns created by using common bingo patterns instead of the typical left to right pay lines. In some embodiments, the patterns evaluated may all have a base pay based on probability, and each symbol may have a multiplier that combines with the pattern pay. In other embodiments, the patterns must be filled with like symbols to award pays.

Numerous variations are possible using these and other embodiments of the inventive concept. Some of these embodiments and variations are discussed below with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, or other games of chance. Some of these other types of embodiments will be discussed below as variations to the examples illustrated. However, many other types of games can implement similar techniques and fall within the scope of this inventive concept.

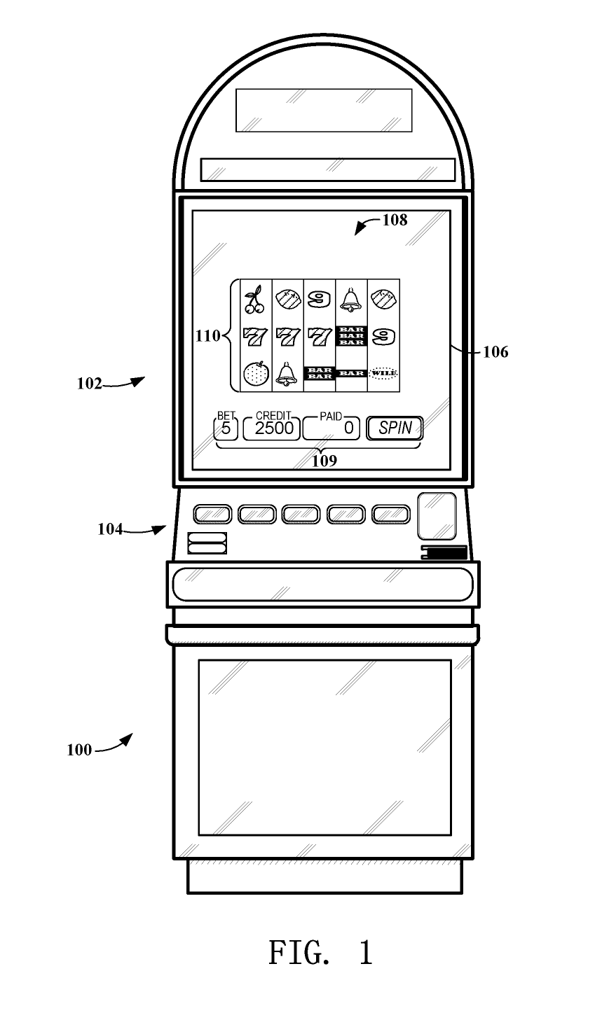

Referring to the example gaming apparatus 100 shown in FIG. 1, the gaming apparatus includes a display area 102 (also referred to as a gaming display), and a player interface area 104, although some or all of the interactive mechanisms included in the user interface area 104 may be provided via graphical icons used with a touch screen in the display area 102 in some embodiments. The display area 102 may include one or more game displays 106 (also referred to as “displays” or “gaming displays”) that may be included in physically separate displays or as portions of a common large display. Here, the game display 106 includes a primary game play portion 108 that displays game elements and symbols 110, and an operations portion 109 that can include meters, various game buttons, or other game information for a player of the gaming device 100.

The user interface 104 allows the user to control and engage in play of the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, or any other user input system or mechanism that allows the user to play the particular gaming activity.

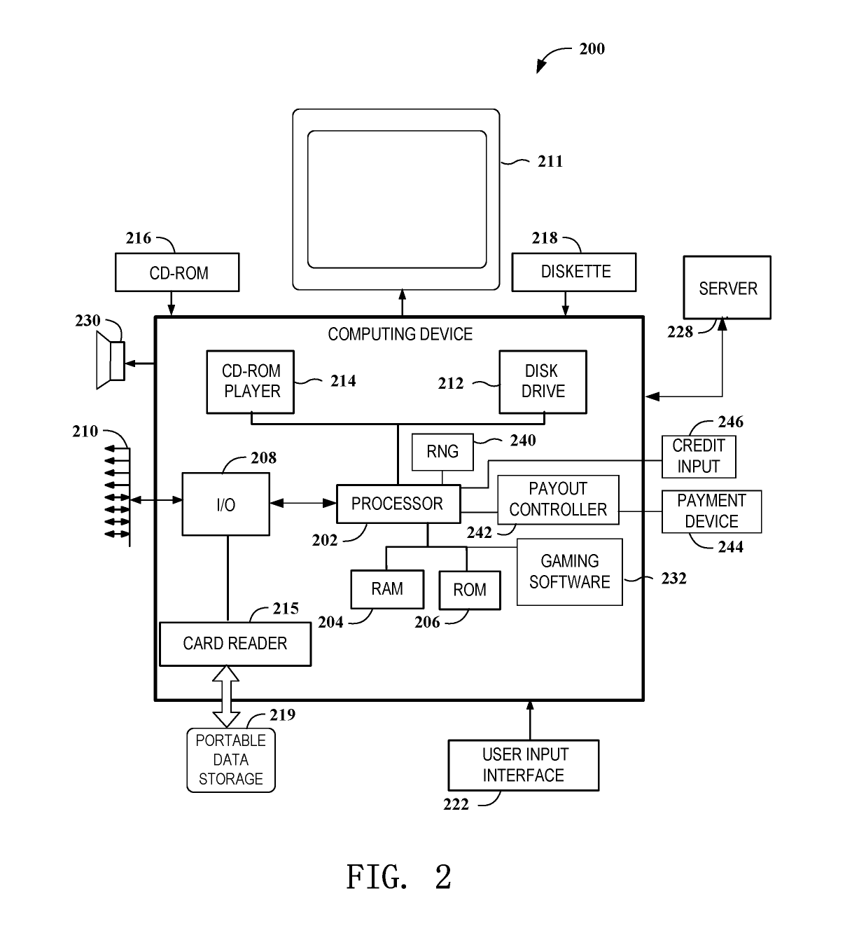

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player loyalty information to identify a user or player of the gaming device. This mechanism may be card reader, biometric scanner, keypad, or other input device. It is through the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as paytable information associated with a glass/plastic panel on the gaming machine 100 and/or graphical images. The symbols or other indicia associated with the play of the game may be presented on an electronic display device or on mechanical devices associated with a mechanical display. Generally, the display 106 devotes the largest portion of viewable area to the primary gaming portion 108. The primary gaming portion 108 is generally where the visual feedback for any selected game is provided to the user. The primary gaming portion 108 may render graphical objects such as cards, slot reels, dice, animated characters, and any other gaming visual known in the art. The primary gaming portion 108 also typically informs players of the outcome of any particular event, including whether the event resulted in a win or loss.

In some the example embodiments illustrated herein, the primary gaming portion 108 may display a grid (or equivalent arrangement) of game elements 110 or game element positions (also referred to as “reel stop positions” herein). As illustrated in the embodiment shown in FIG. 1, the grid includes three rows and five columns of game elements 110, which may form a game outcome of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual symbols, or user controls over stopping or spinning reels. The game display 106 of the display area 102 may include other features that are not shown, such as paytables, navigation controls, etc.

Although FIG. 1 illustrates a particular implementation of some of the embodiments of this invention in a casino or electronic gaming machine (“EGM”), one or more devices may be programmed to play various embodiments of the invention. The present invention may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the invention is illustrated in FIG. 2.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 200 of FIG. 2 is an example computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions in accordance with the present invention typically includes a central processor (CPU) 202 coupled to random access memory (RAM) 204 and some variation of read-only memory (ROM) 206. The ROM 206 may also represent other types of storage media to store programs, such as programmable ROM (PROM), erasable PROM (EPROM), etc. The processor 202 may communicate with other internal and external components through input/output (I/O) circuitry 208 and bussing 210, to provide control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to the display 211, which represents a display on which the gaming activities in accordance with the invention are presented. The display 211 represents the “presentation” of the game information in accordance with the invention, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, or inputting data to identify a player for a player loyalty system. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs may be implemented using hardware, software operable in connection with the processor 202, or some combination of hardware and software. The present invention is operable using any known RNG, and may be integrally programmed as part of the processor 202 operation, or alternatively may be a separate RNG controller 240. The RNGs are often protected by one or more security measures to prevent tampering, such as by using secured circuitry, locks on the physical game cabinet, and/or remote circuitry that transmits data to the gaming device. The computing arrangement 200 may be connected to other computing devices or gaming machines, such as via a network. The computing arrangement 200 may be connected to a network server 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 indicating a payout is to made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player. A payout device 244 may also be provided in gaming machine embodiments, where the payout device 244 serves as the mechanism providing the payout to the player or participant. In some embodiments, the payout device may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, etc., for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payout device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described hereinabove. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a paytable. The software 232 may include instructions to provide other functionality as known in the art or as described and shown herein.

As discussed above, embodiments of the present concept include providing gaming devices, gaming systems, and methods of operating these devices or systems to provide game play that utilizes operations of providing pattern-based award evaluations in gaming devices. In one embodiment, a method of operating a gaming device includes evaluating symbol patterns created by using common bingo patterns instead of the typical left to right pay lines. In some embodiments, the patterns evaluated may all have a base pay based on probability, and each symbol may have a multiplier that combines with the pattern pay. In other embodiments, the patterns must be filled with like symbols to award pays.

In some embodiments, each pattern that is put into the game pays a given amount. For example, the following pays may be included in a game:

Straight Line pays—pays 1

4 Corners—pays 2

Postage stamp—pays 5

Additionally, the pays are then multiplied by the symbols that land in these patterns. So, in the above example, the following multiplier table may also be included in the gaming device and used to determine final awards for each game with the above pay information:

F4, F5—1x

F6—2X

M3—3X

M2—4X

M1—5X

So, for example, if a player receives M1 symbols in the Postage Stamp win pattern, during a gaming event, the player would win 25.

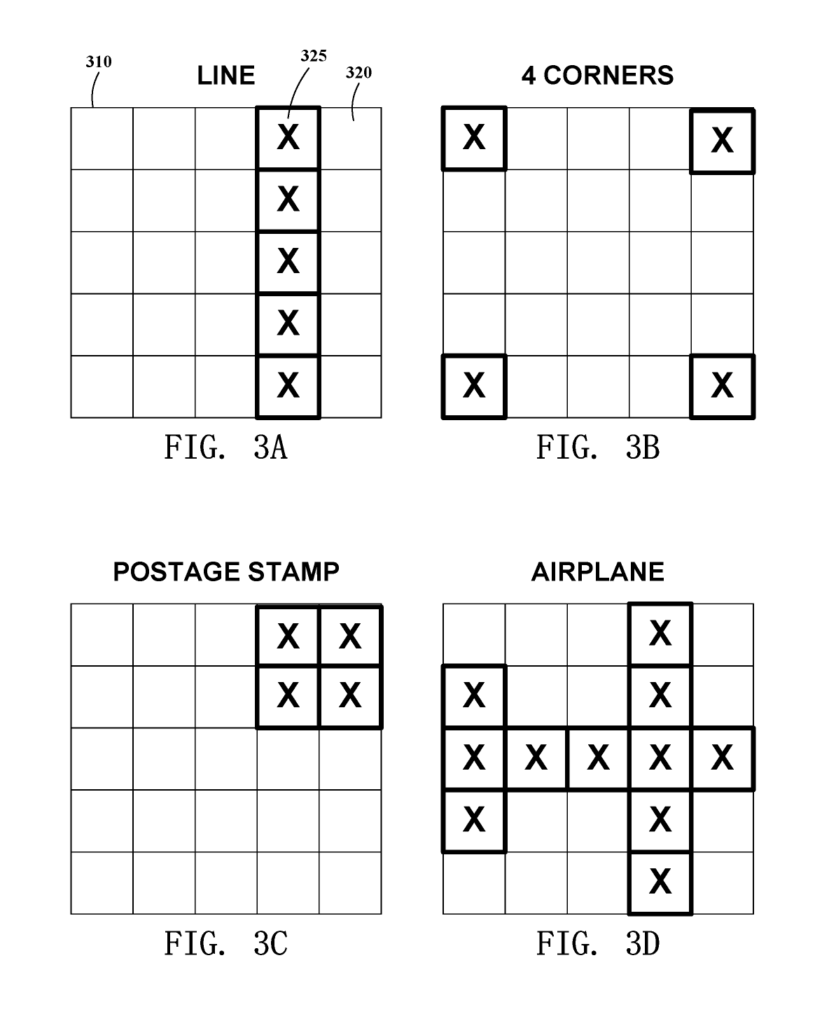

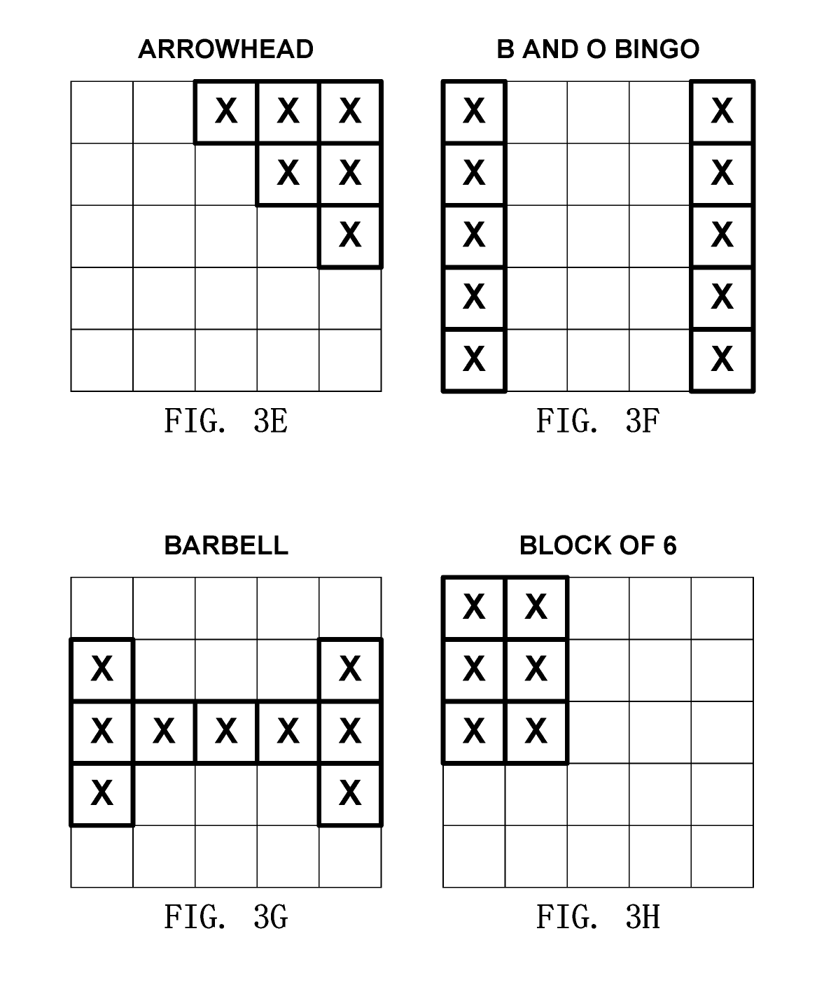

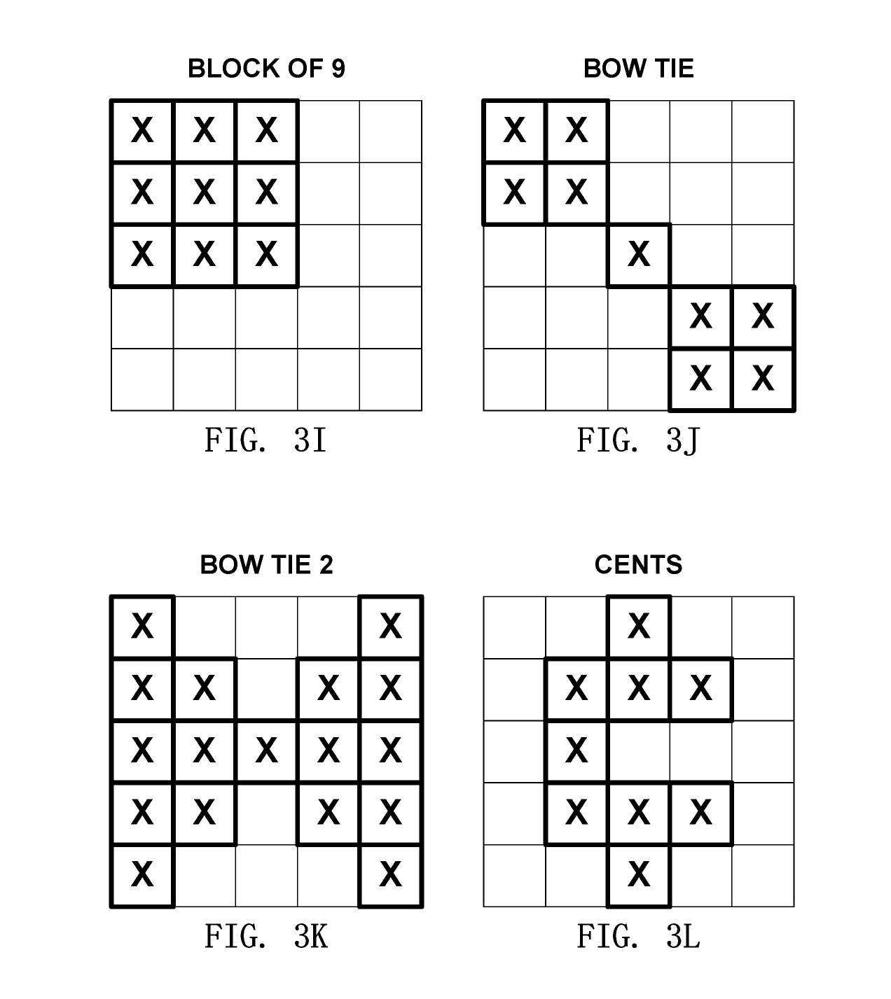

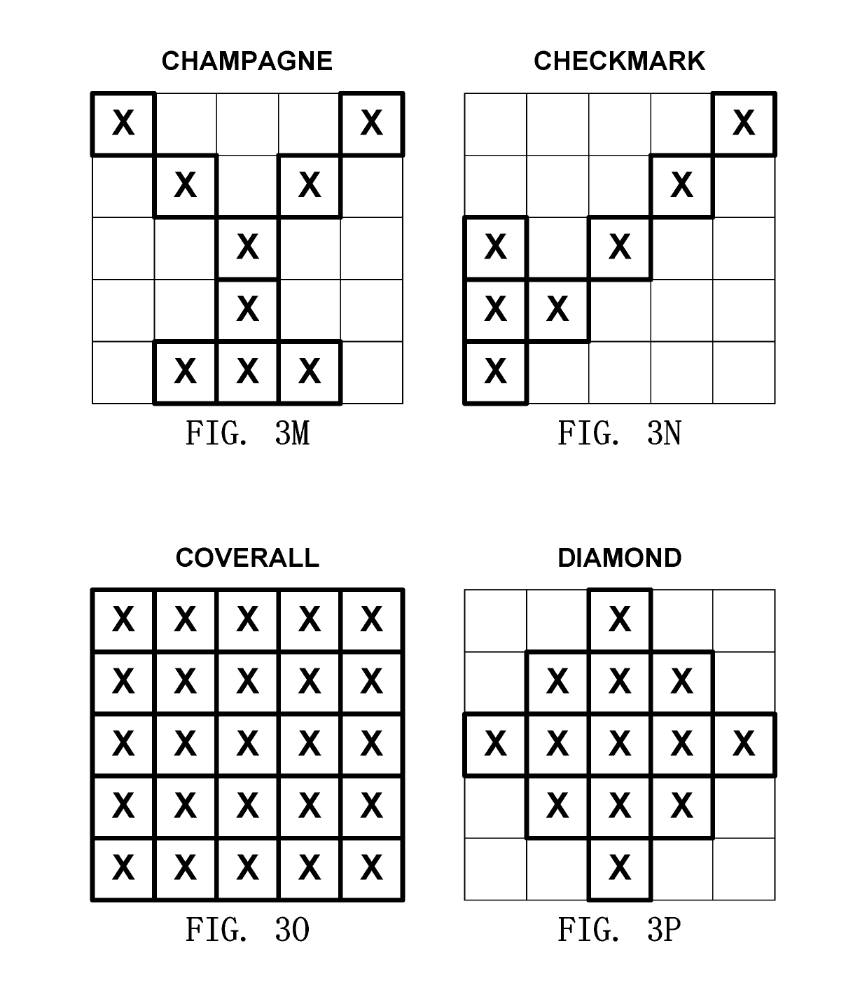

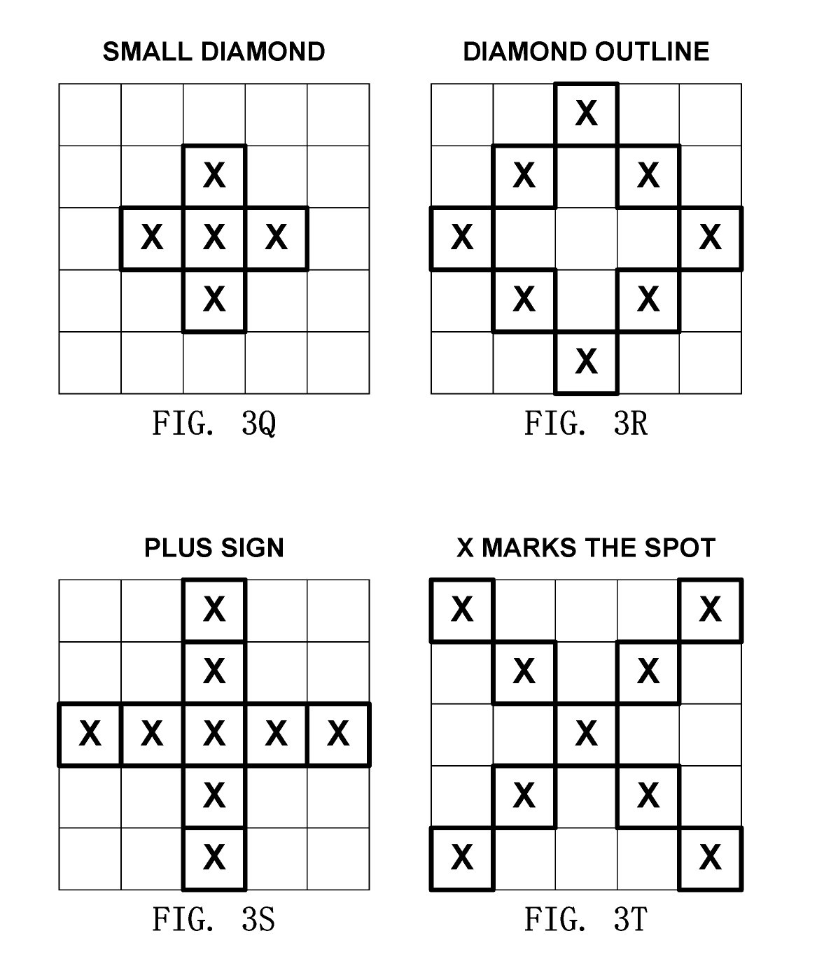

FIGS. 3A-3T illustrates a number of different patterns that could be used in addition to the above described patterns to generate additional pay opportunities. Here, example game grids 310 a plurality of symbol positions 320 and have marked symbol positions 325 corresponding to patterns evaluated for awards.

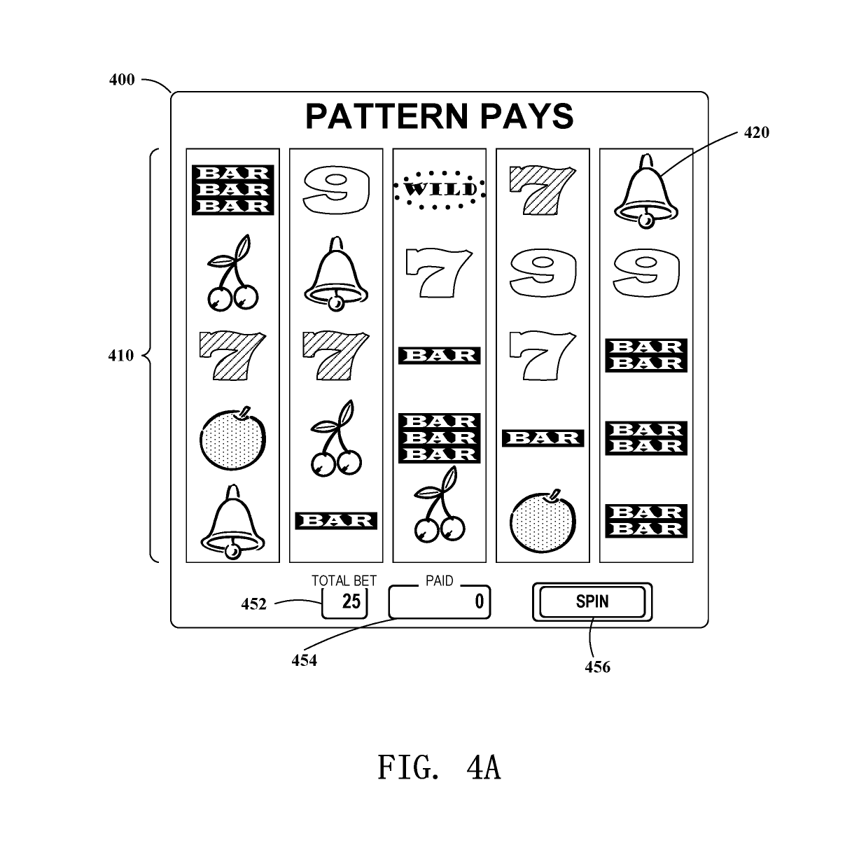

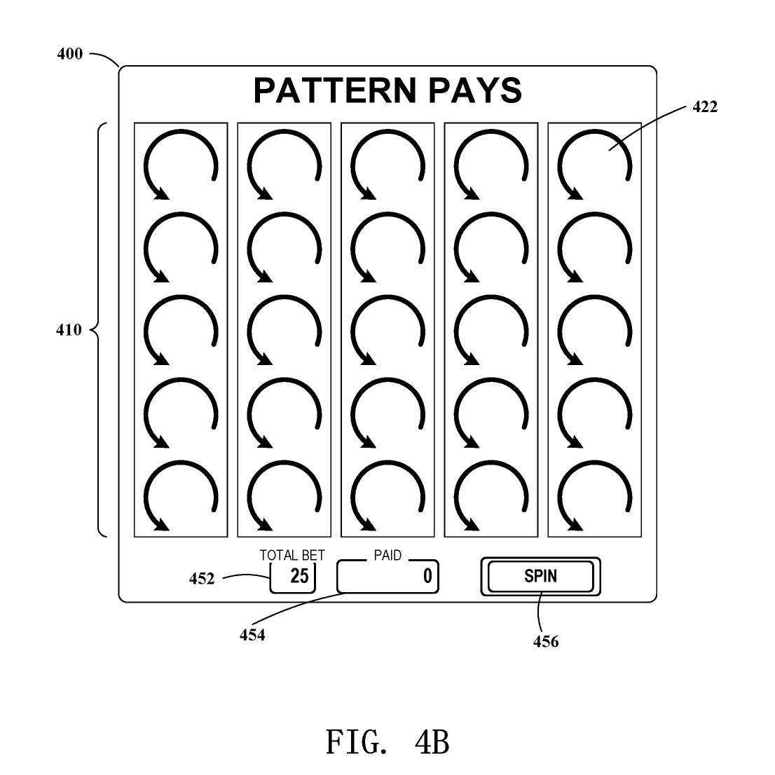

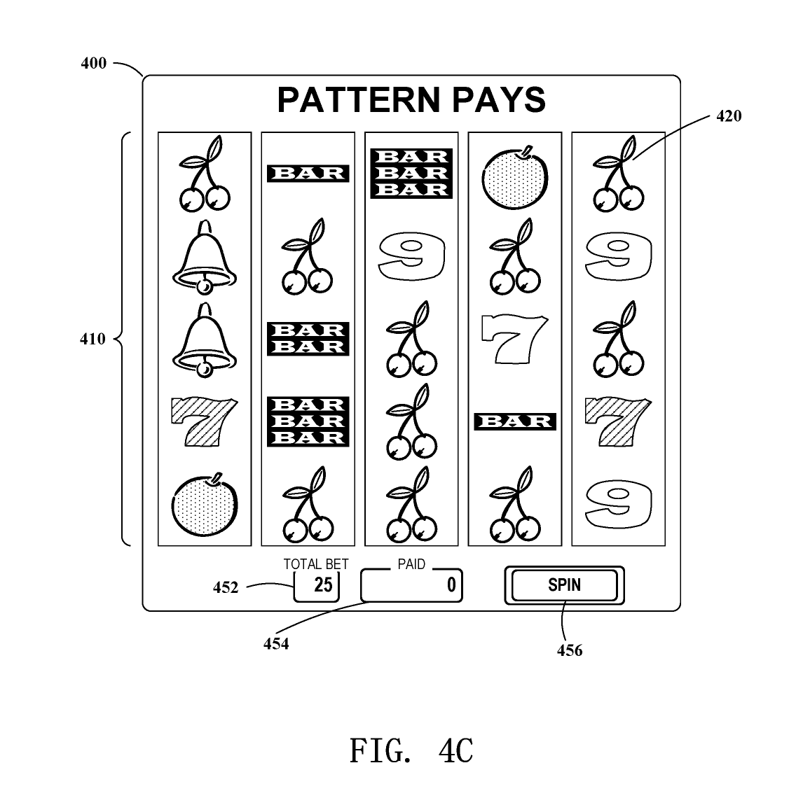

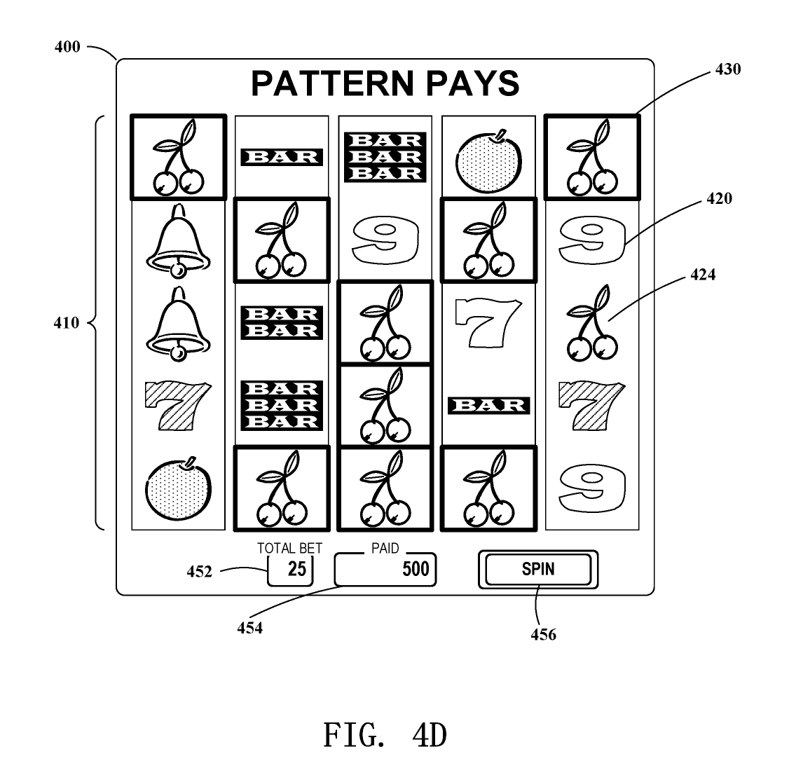

FIGS. 4A-4D are detail diagrams of a gaming display 400 showing an example game progression using pattern-based evaluation techniques. Referring to FIG. 4A, the gaming display 400 includes a game grid 410 of symbol positions that show portions of a plurality of game reels each having multiple gaming symbols 420. The gaming display 400 may also include an interface portion that includes various meters and buttons, such as a Total Bet meter 452, a Paid meter 454, and a SPIN button 456, so that players can interact with the gaming device.

In FIG. 4A, the outcome of a first gaming event does not result in a winning pattern combination. In FIG. 4B, another wager has been placed in the reels spin to randomly display new symbols in a second game outcome. Here, the game reels may be dependent, where each column of the game grid 410 is part of a respective game reel, or the game reels may be independent where each symbol position in the game grid includes its own respective reel. In some embodiments, the independent reels may exhibit some dependency (pseudo-independent reels) that influences or forces certain symbol positions on the grid to land together on the same symbol. This can be done from a weighted table based on position, or by other means. Having pseudo-independent reels may help with patterns that require a large number of symbols to match. In FIG. 4C, the outcome of the second gaming event is shown. Here, the cherry symbols match the “champagne” pattern and the player wins 500 credits. The winning pattern symbol combination may be highlighted 430, as shown in FIG. 4D, so that wins are easily identifiable.

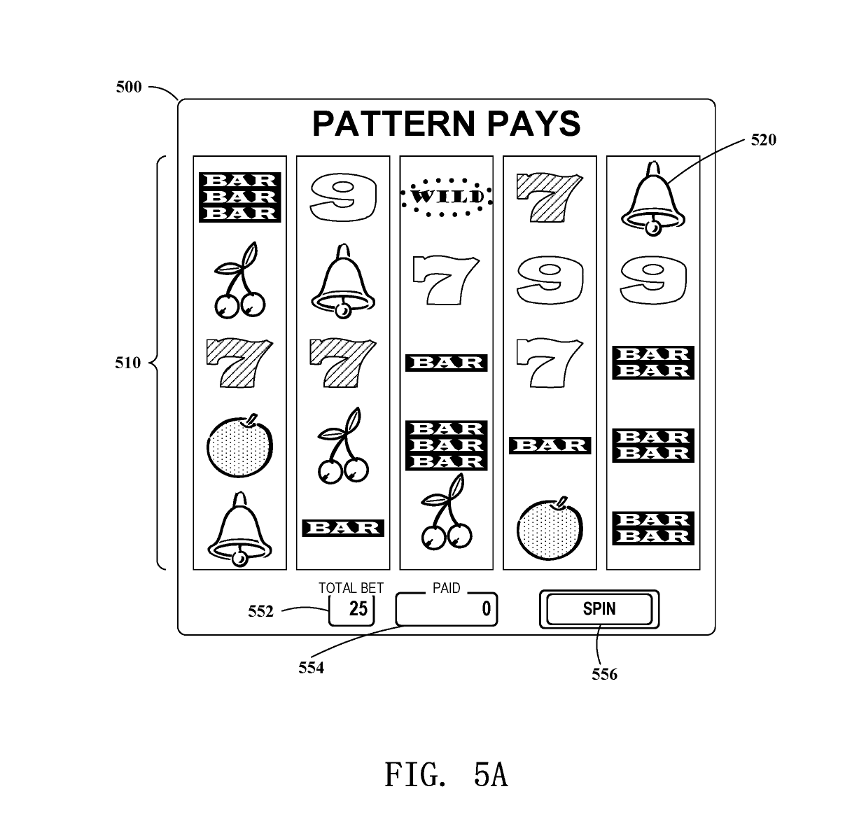

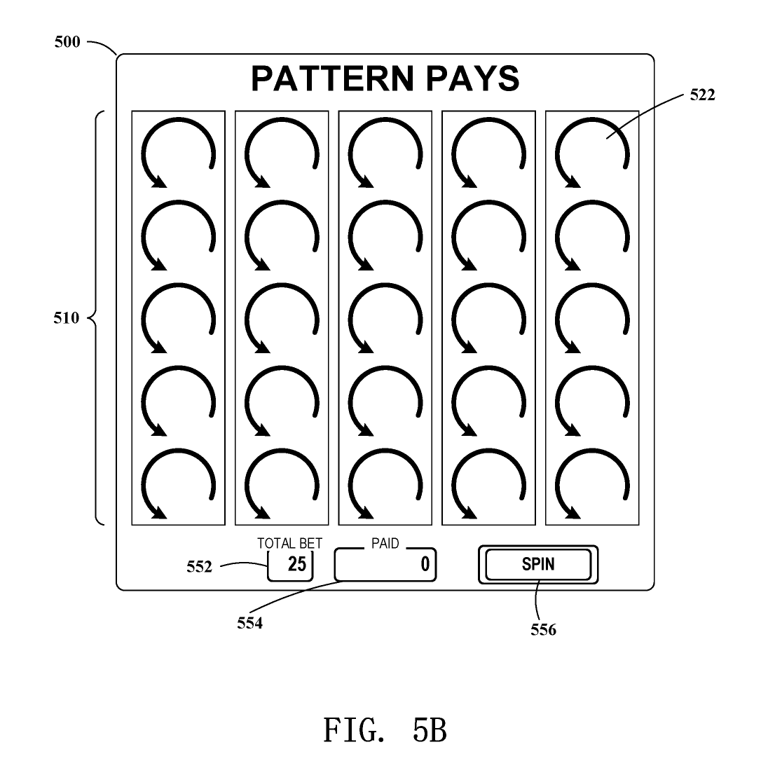

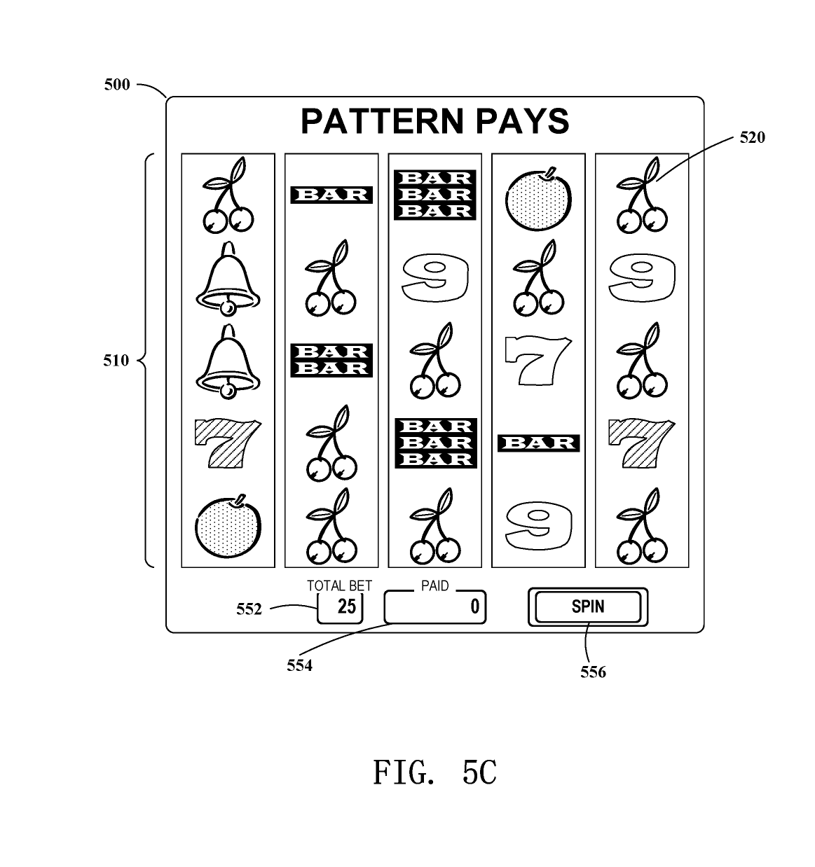

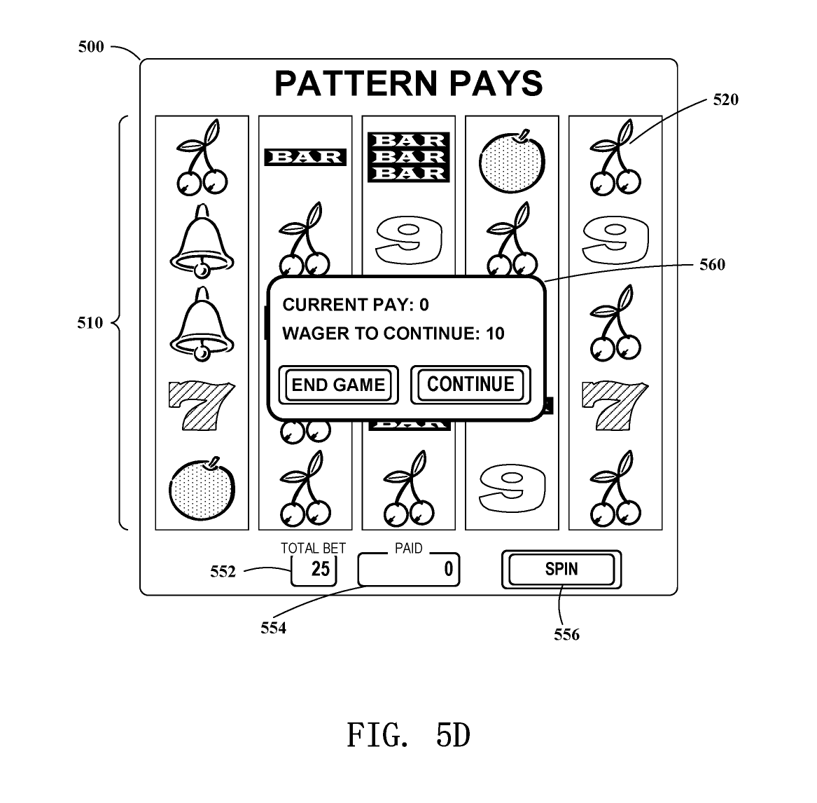

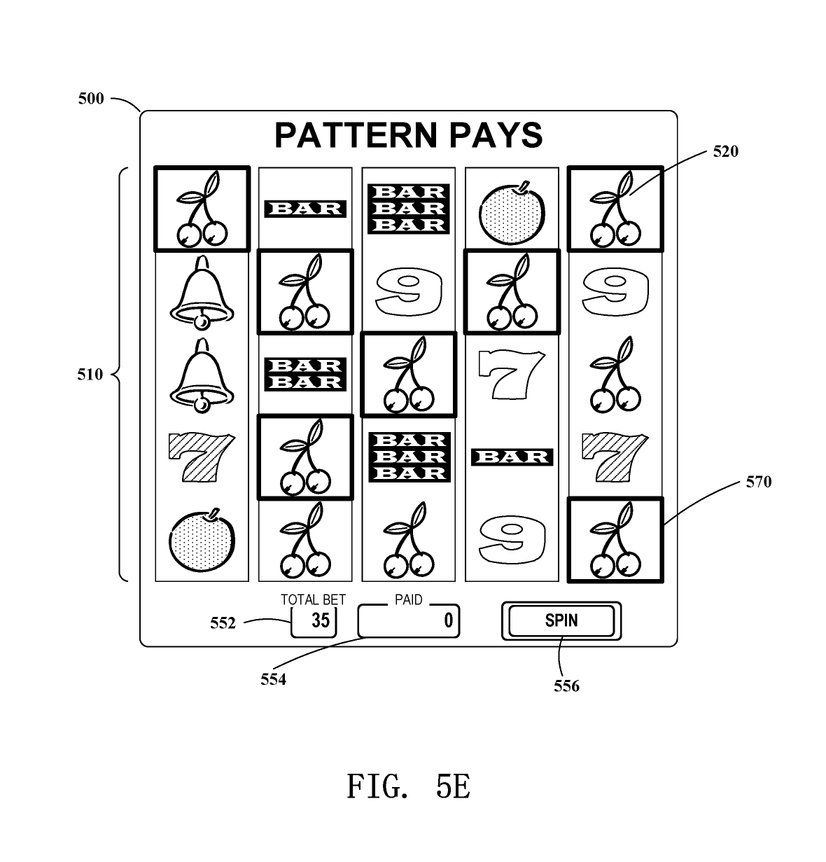

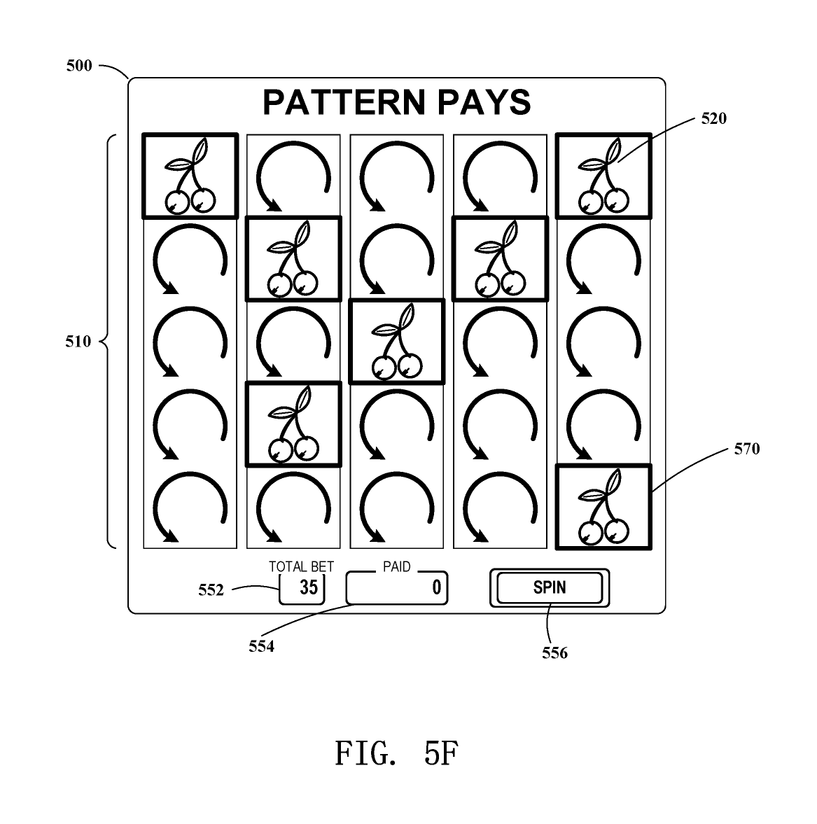

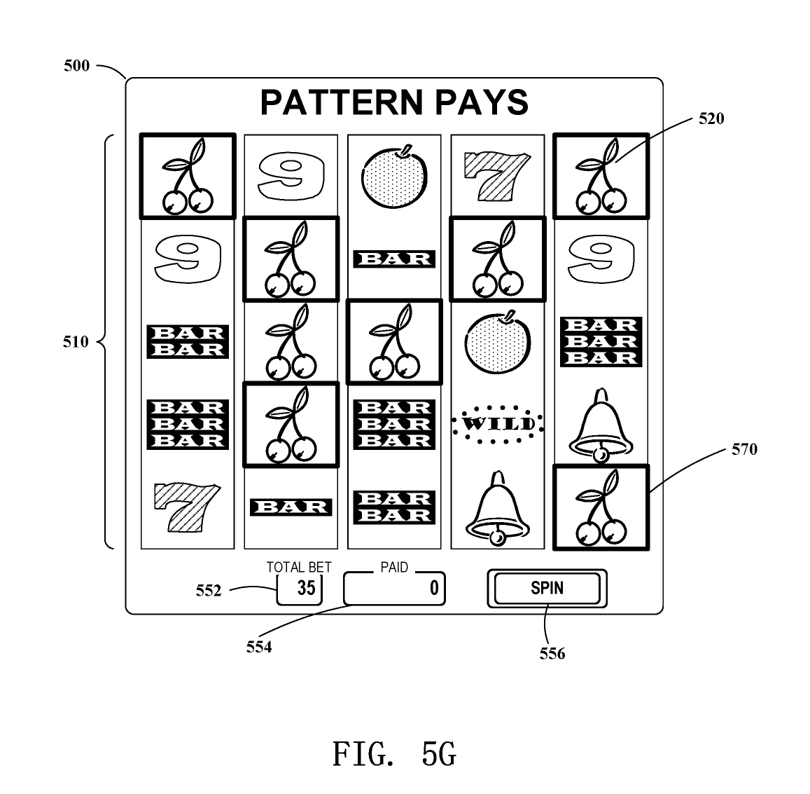

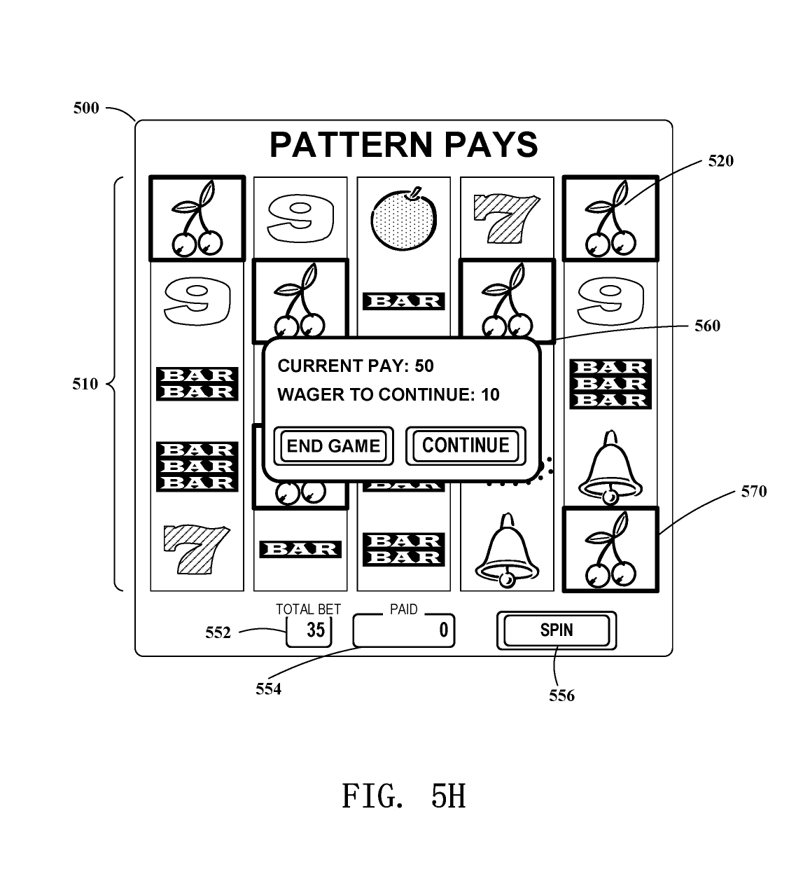

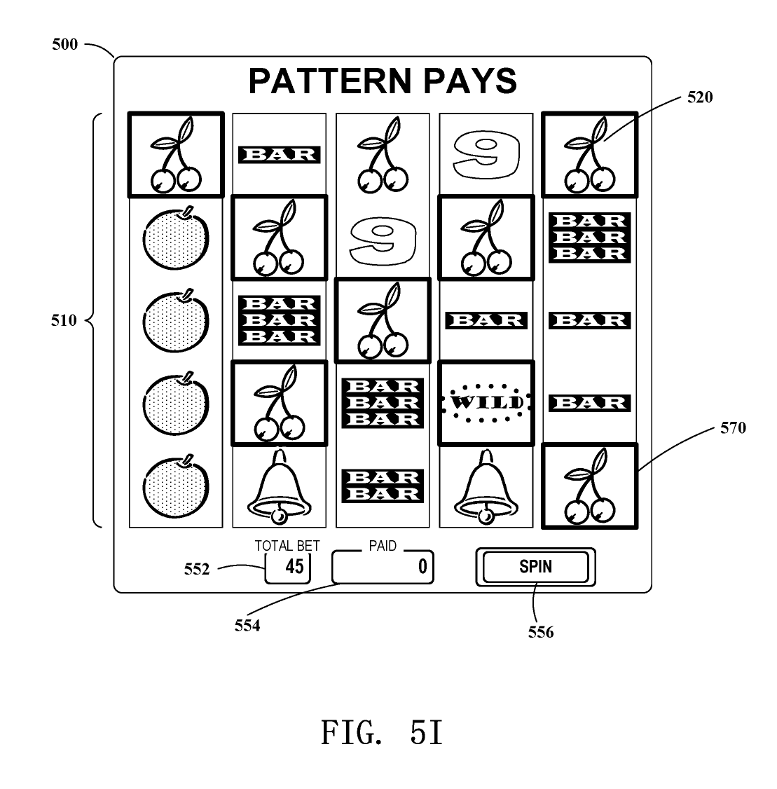

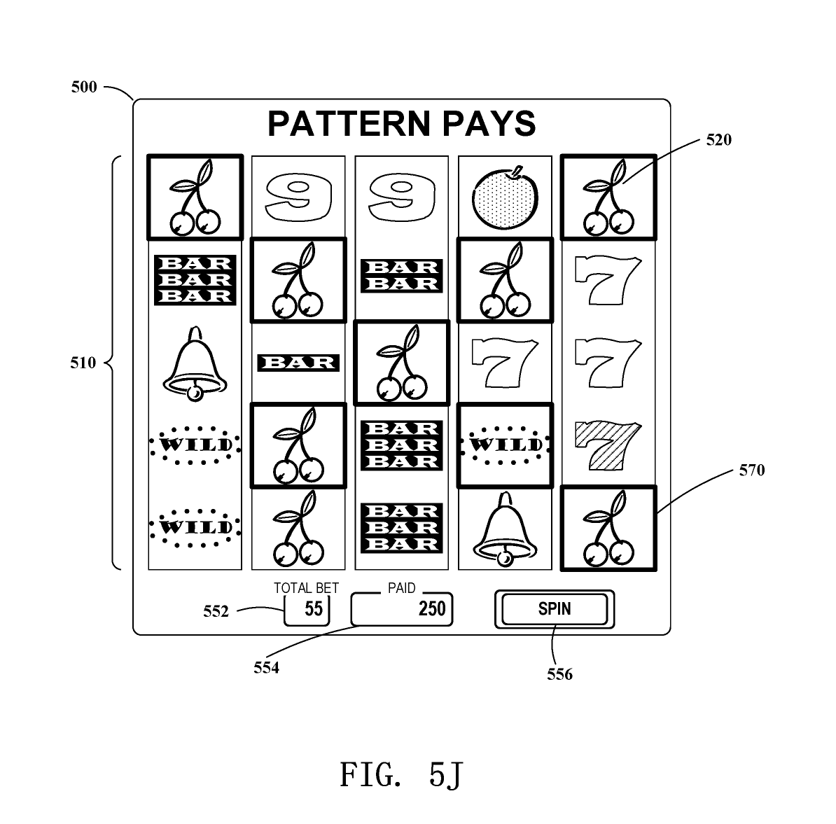

FIGS. 5A-5J are detail diagrams of a gaming display 500 showing an example game progression using pattern-based evaluation techniques. Referring to FIG. 5A, the gaming display 500 includes a game grid 510 of symbol positions that show portions of a plurality of game reels each having multiple gaming symbols 520. The gaming display 500 may also include an interface portion that includes various meters and buttons, such as a Total Bet meter 552, a Paid meter 554, and a SPIN button 556, so that players can interact with the gaming device. FIGS. 5A-5J illustrate an embodiment, where after a game event, a player has the option of taking an outcome/award, or paying an additional wager to try for a higher paying pattern. In some embodiments, a player may have a limited number of opportunities to try for better symbol patterns, while in other embodiments, a player may keep spending additional money to chase elusive outcome patterns.

In FIG. 5A, the outcome of a first gaming event does not result in a winning pattern combination. In FIG. 5B, another wager has been placed in the reels spin to randomly display new symbols in a second game outcome. Here, the game reels may be dependent, where each column of the game grid 510 is part of a respective game reel, or the game reels may be independent where each symbol position in the game grid includes its own respective reel. In FIG. 5C, the outcome of the second gaming event is shown. Here, the cherry symbols are close to two line plays (along the diagonals) and two symbols away from the “X” pattern. In FIG. 5D, a selection screen 560 appears to give the player the choice of spending additional wagers to chase a better paying (or any paying) pattern. The amount of the side bet needed to keep playing may be dynamically calculated based on the probability of the player completing the desired patter, or could be a fixed number.

In FIG. 5E, the player has chosen to keep playing and the cherry symbols corresponding to the “X” pattern are locked 570 in place for the next reel spin (which may be part of the same game event or part of the next game event). The cherry symbols may be automatically locked by the game processor assuming that is the best play with the most favorable outcome, or a player may have to lock each symbol that they want to maintain prior to the next reel spin. In FIG. 5F, the non-locked reel positions are re-spun, and in FIG. 5G, the next game outcome is shown. Here, the player has completed one of the diagonal pays with the newly received wild symbol. In FIG. 5H, the player again has the chance to accept the award for the line pay (50 credits) or place another 10 credits to go for a bigger award. In FIG. 5I, the player has locked the wild, paid an extra 10 credits and has gone for the bigger “X” pattern pay. Unfortunately, this game does not result in a pay for the player. However, the player again bets (up to 55 credits now wagered) and goes for the “X” pattern pay. As shown in FIG. 5J, the player gets the pattern play and the corresponding 250 credit award. He also has the ability to trade in this value and go for a bigger award on a different pattern.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out above and in the appended claims.

1. A gaming device comprising:
a video display device configured to display a game grid showing portions of a plurality of game reels having multiple game symbols in a matrix of symbol positions;
a memory device configured to store a credit amount, store a plurality of evaluation patterns for the game grid, and store a paytable of multiplier values each associated with a game symbol;
a wager input device structured to receive physical items associated with currency values; and
a processor operable to:
receive a signal from the wager input device indicating receipt of a physical item associated with a currency value;
increase the credit amount stored in the memory based on the currency value of the received physical item;
receive a wager on a gaming event, where an amount of the wager is deducted from the credit amount stored in the memory;
display a first game outcome on the game grid;
evaluate the first game outcome on the game grid using the stored evaluation patterns in the memory to determine is one or more the patterns have been satisfied based on the first game outcome;
multiply a corresponding multiplier value of a symbol satisfying the one or more patterns, with a pattern paytable value; and
increase the credit amount stored in memory by amounts of any awards determined from the evaluation of the second game outcome.

2. The gaming device of claim 1, wherein at least one of the stored evaluation pattern includes a grouping of symbol positions of the game grid that are not adjacent to one another.
